(19) United States
(12) Patent Application Publication
(10) Pub. No.: US 2013/0021421 A1
(43) Pub. Date: Jan. 24, 2013

(54) MULTICOLOR THERMOSENSITIVE MEDIUM AND PRINTING APPARATUS

(71) Applicant: BROTHER KOGYO KABUSHIKI KAISHA, Nagoya-shi (JP)

(72) Inventors: Ryosuke ISHIKAWA, Nagoya-shi (JP); Koshiro YAMAGUCHI, Kakamigahara-shi (JP); Susumu MURATA, Konan-shi (JP); Tsutomu KATO, Nagoya-shi (JP)

(73) Assignee: BROTHER KOGYO KABUSHIKI KAISHA, Nagoya-shi (JP)

(21) Appl. No.: 13/627,586

(22) Filed: Sep. 26, 2012

Related U.S. Application Data
(63) Continuation-in-part of application No. PCT/JP2011/072320, filed on Sep. 29, 2011.

(30) Foreign Application Priority Data
Sep. 30, 2010 (JP) 2010-222141

(51) Int. Cl. B41J 35/16

(52) U.S. Cl. 347/172

(57) ABSTRACT

In a multicolor thermosensitive medium and a printing apparatus, the multicolor thermosensitive medium includes: a base material; and a plurality of coloring layers including: a lamination group laminated on the base material and including one or more lower coloring layers; and an upper coloring layer laminated on the lamination group and having higher hiding properties at a portion where a color is developed than the lower coloring layers, wherein each coloring layer has coloring properties different from each other with regard to a heating temperature level necessary for color development, and wherein the upper coloring layer develops the color at a higher temperature than any of the lower coloring layers in the lamination group, and wherein the printing apparatus includes: a thermal head that applies thermal energy to the multicolor thermosensitive medium from a direction of the upper coloring layer.

### CROSS-REFERENCE TO RELATED APPLICATIONS

The present application is a continuation-in-part application based upon and claims the benefit of the prior PCT International Patent Application No. PCT/JP2011/072320 filed on Sep. 29, 2011, the disclosure of which is herein incorporated by reference in its entirety.

### TECHNICAL FIELD

The disclosure relates to a multicolor thermosensitive medium provided with a plurality of coloring layers, and a printing apparatus.

### BACKGROUND

As a technique relating to the multicolor thermosensitive medium having a plurality of coloring layers and the printing apparatus using thereof, there has conventionally been proposed, for instance, color thermosensitive recording paper including a black coloring layer therein to form a four-layered structure. Further, there is conventionally proposed a multicolor thermosensitive printing apparatus of a thermal recording system utilizing multicolor thermosensitive paper having a thermosensitive layer formed through applying hot-melting inks of four colors; yellow, magenta, cyan and black, whose melting points are different from each other, in a laminated manner on a base material.

Here, with a conventional printing apparatus, in a case of developing a color at the black coloring layer among the plurality of coloring layers in the multicolor thermosensitive medium, larger amount of application energy is required than in cases of developing a color at yellow, magenta or cyan coloring layer. In other words, the amount of application energy required to develop the color at the black coloring layer is sufficient to develop the color at the yellow, magenta or cyan coloring layer. Accordingly, if the color is to be developed at the black coloring layer in the multicolor thermosensitive medium with the printing apparatus, the yellow, magenta or cyan coloring layer may also develop the color and color mixture may sometimes be conspicuous, depending on the structure of the multicolor thermosensitive medium or the application control of the printing apparatus.

### SUMMARY

The disclosure has been made to solve the above-described problem and has an object to provide a multicolor thermosensitive medium and a printing apparatus that allow clear and sharp printing with a distinct outline or character, while preventing color mixture therein.

To achieve the purpose of the disclosure, there is provided a multicolor thermosensitive medium and a printing apparatus, wherein the multicolor thermosensitive medium comprises: a base material; and a plurality of coloring layers comprising: a lamination group laminated on the base material and comprising one or more lower coloring layers each of which develops a basic color; and an upper coloring layer that develops a color different from basic colors developed at the lower coloring layers, the upper coloring layer laminated on the lamination group and having higher hiding properties at a portion where the color is developed than the lower coloring layers, wherein each coloring layer has coloring properties different from each other with regard to a heating temperature level necessary for color development; and wherein the upper coloring layer develops the color at a higher temperature than any of the lower coloring layers in the lamination group, and wherein the printing apparatus comprises: a thermal head that applies thermal energy to the multicolor thermosensitive medium from a direction of the upper coloring layer; and a control means that drives the thermal head, wherein the control means controls a heating temperature at the thermal head by a unit of print cycle, in accordance with coloring properties of a coloring layer to be developed among the upper coloring layer and the lower coloring layers.

Furthermore, according to another aspect, there is provided a multicolor thermosensitive medium and a printing apparatus, wherein the multicolor thermosensitive medium comprises: a base material; and a plurality of coloring layers comprising: a lamination group laminated on the base material and comprising one or more lower coloring layers each of which develops a basic color; and an upper coloring layer that develops a color different from basic colors developed at the lower coloring layers, the upper coloring layer laminated on the lamination group and having higher hiding properties at a portion where the color is developed than the lower coloring layers, wherein each coloring layer has coloring properties different from each other with regard to a heating temperature level necessary for color development, and wherein the upper coloring layer develops the color at a higher temperature than any of the lower coloring layers in the lamination group, wherein the printing apparatus comprises: a thermal head that applies thermal energy to the multicolor thermosensitive medium from a direction of the upper coloring layer; and a control means that drives the thermal head, wherein the control means controls a heating temperature at the thermal head by a unit of print cycle, in accordance with coloring properties of a coloring layer to be developed among the upper coloring layer and the lower coloring layers, wherein the color to be developed at the upper coloring layer is black, and wherein the lamination group comprises three lower coloring layers, at which colors to be developed are cyan, magenta and yellow, respectively.

### BRIEF DESCRIPTION OF THE DRAWINGS

FIG. 1 is a schematic sectional view of a multicolor thermosensitive medium;

FIG. 2 is a graph indicating coloring properties of cyan, magenta, yellow and black coloring layers in the multicolor thermosensitive medium;

FIG. 3 is a graph indicating coloring properties of cyan, magenta, yellow and black coloring layers in the multicolor thermosensitive medium;

FIG. 4 is a schematic view of the multicolor thermosensitive medium in developing colors in two consecutive units of print cycles using a thermal head of a printing apparatus;

FIG. 5 is a schematic view of waveforms of driving voltage applied to the thermal head of the printing apparatus, showing application durations in the two consecutive units of print cycles;

FIG. 6 is a schematic view of the multicolor thermosensitive medium in developing colors in two consecutive units of print cycles using the thermal head of the printing apparatus;

FIG. 7 is a schematic view of waveforms of driving voltage applied to the thermal head of the printing apparatus, showing application durations in the two consecutive units of print cycles; and

FIG. 8 is a block diagram of the printing apparatus.

### DETAILED DESCRIPTION

A detailed description of an exemplary embodiment of a multicolor thermosensitive medium and a printing apparatus embodying the disclosure will now be given referring to the accompanying drawings.

### [1. Multicolor Thermosensitive Medium]

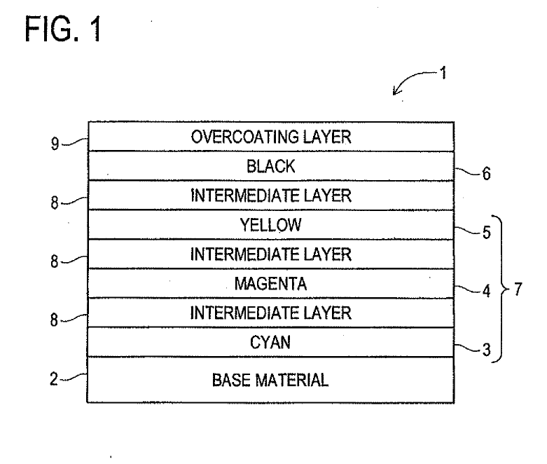

As illustrated in FIG. 1, a multicolor thermosensitive medium 1 includes a base material 2. On the base material 2, cyan, magenta, yellow and black coloring layers 3, 4, 5, 6 are laminated in this order. The cyan, magenta and yellow coloring layers 3, 4, 5 integrally form a lamination group 7 laminated on the base material 2. Meanwhile, the black coloring layer 6 is laminated over the lamination group 7 and develops a black color which is a different kind from each color of the cyan, magenta and yellow coloring layers 3, 4, 5. The black coloring layer 6 possesses superior hiding properties at color development to those of the cyan, magenta and yellow coloring layers 3, 4, 5.

Furthermore, intermediate layers 8 are laminated between the cyan, magenta, yellow and black coloring layers 3, 4, 5, 6, respectively. On top of the black coloring layer 6, an overcoating layer 9 is laminated.

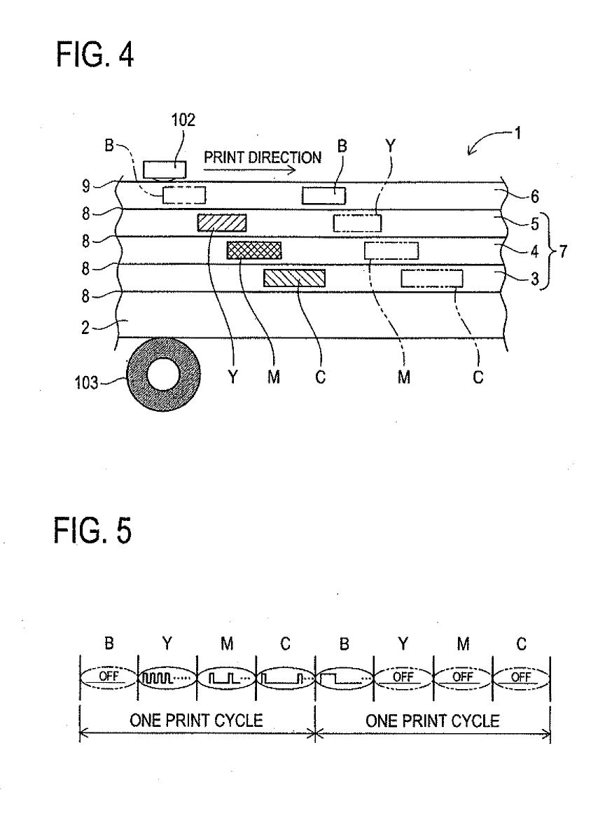

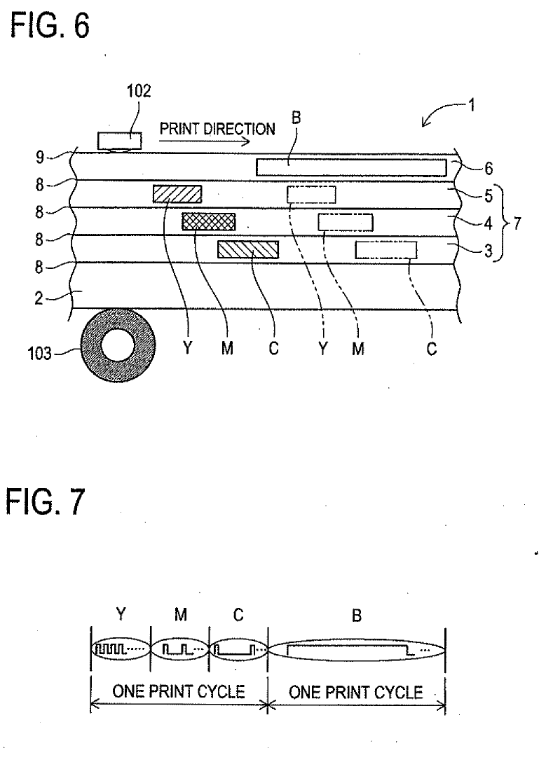

Incidentally, hatching for indicating section portions of the base material 2, the cyan, magenta, yellow and black coloring layers 3, 4, 5, 6, the intermediate layer 8, and the overcoating layer 9 is omitted in the schematic sectional view of the multicolor thermosensitive medium 1 shown in FIG. 1, for the purpose of avoiding too many lines disturbing view of the section of the multicolor thermosensitive medium 1. Similar omission is employed in FIG. 4 and FIG. 6 to be later described. In addition to that, in FIG. 4 and FIG. 6, the section portions of the intermediate layers 8 and the overcoating layer 9 are illustrated each with a solid line, ignoring thickness thereof.

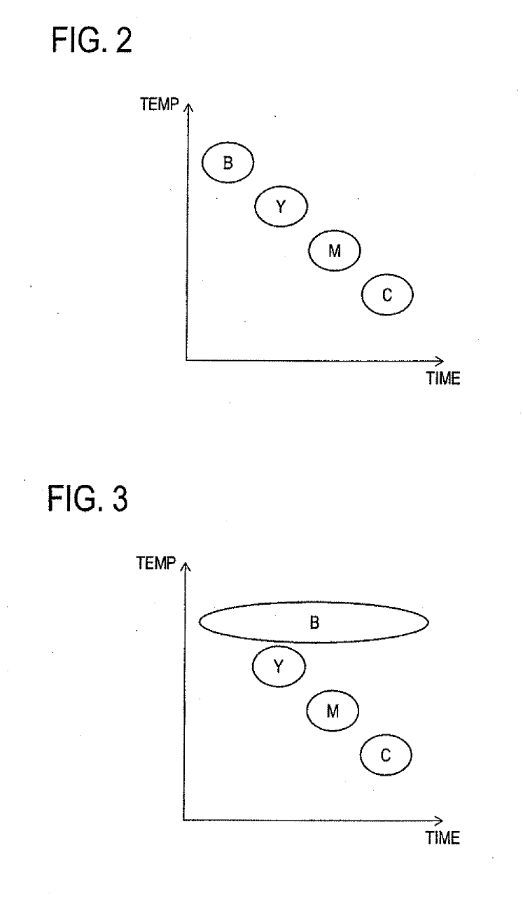

FIG. 2 and FIG. 3 illustrate the heating temperature levels and the time durations (tolerable duration of heating) necessary for color development with regard to the cyan, magenta, yellow and black coloring layers 3, 4, 5, 6, and indicate that coloring properties for developing colors therein are different from each other.

In FIG. 2 and FIG. 3, “B” stands for the black coloring layer 6, “Y” stands for the yellow coloring layer 5, “M” stands for the magenta coloring layer 4 and “C” stands for the cyan coloring layer 3.

As shown in FIG. 2 and FIG. 3, the black coloring layer 6 develops a color at a higher temperature than those for the cyan, magenta and yellow coloring layers 3, 4, 5 forming the lamination group 7.

With respect to the coloring properties shown in FIG. 2, the cyan, magenta, yellow and black coloring layers 3, 4, 5, 6 have relatively different heating temperatures and durations necessary for color development. For instance, the black coloring layer 6 develops a color at heat application for 1 ms at 190 degrees Celsius, the yellow coloring layer 5 develops a color at heat application for 3 ms at 160 degrees Celsius, the magenta coloring layer 4 develops a color at heat application for 5 ms at 130 degrees Celsius, and the cyan coloring layer 3 develops a color at heat application for 8 ms at 100 degrees Celsius.

Meanwhile, with respect to the coloring properties shown in FIG. 3, the cyan, magenta and yellow coloring layers 3, 4, 5, which make up the lamination group 7, have different time durations necessary for color development from each other in addition to different heating temperature levels necessary for color development, respectively. The black coloring layer 6 similarly has its own heating temperature level necessary for color development in addition to its own time duration necessary for color development; however, the heating temperature level necessary for color development of the black coloring layer 6 is higher than any of the heating temperature levels necessary for color development of the cyan, magenta and yellow coloring layers 3, 4, 5, and further, the time duration necessary for color development of the black coloring layer 6 includes all of the time durations necessary for color development of the cyan, magenta and yellow coloring layers 3, 4, 5. For instance, the yellow coloring layer 5 develops a color at heat application for 3 ms at 160 degrees Celsius, the magenta coloring layer 4 develops a color at heat application for 5 ms at 130 degrees Celsius, and the cyan coloring layer 3 develops a color at heat application for 8 ms at 100 degrees Celsius, whereas the black coloring layer 6 develops a color at heat application for 10 ms at 190 degrees Celsius. Here, the black coloring layer 6 develops a color even less than 10 ms.

Furthermore, as shown in FIG. 2 and FIG. 3, with regard to the cyan, magenta and yellow coloring layers 3, 4, 5, the duration necessary for color development is the longest at the coloring layer laminated the closest to the base material and gets shorter upwards in the lamination order. That is, the duration necessary for color development is the longest at the cyan coloring layer 3 located the closest to the base material, and gets shorter at the magenta and yellow coloring layers 4, 5 in this order, as going upwards the order of lamination.

Still further, when two or more coloring layers from among the cyan, magenta and yellow coloring layers 3, 4, 5 develop colors, a color developed thereat is visually different from a color developed by one of the cyan, magenta and yellow coloring layers 3, 4, 5 singly.

### [2. Printing Apparatus]

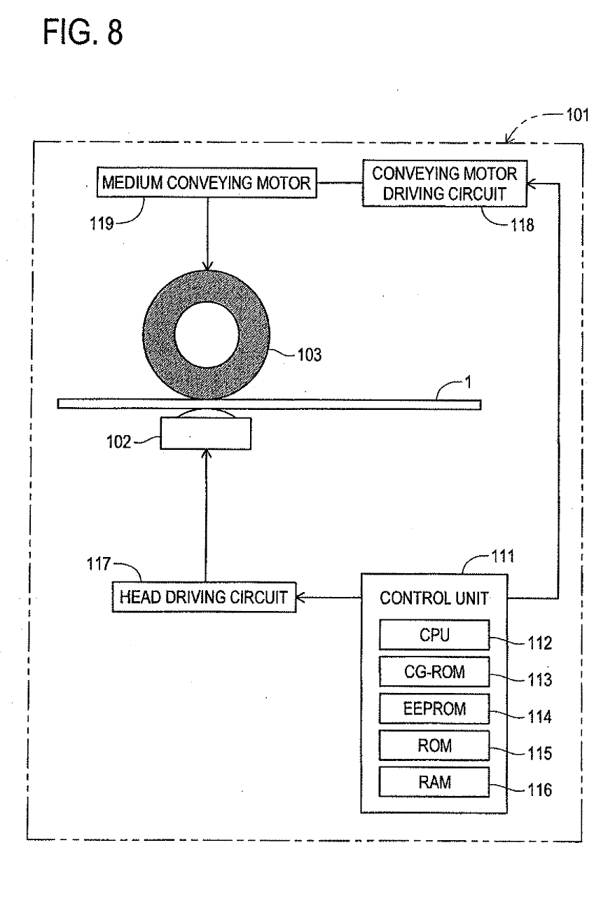

As illustrated in FIG. 8, a printing apparatus 101 includes, a thermal head 102, a platen roller 103, a control unit 111, a head driving circuit 117, a conveying motor driving circuit 118 and a medium conveying motor 119. The multicolor thermosensitive medium 1 is held between the thermal head 102 and the platen roller 103, and conveyed by the rotation of the platen roller 103.

The control unit 111 includes a CPU 112, CG-ROM 113, EEPROM 114, ROM 115 and RAM 116. The CPU 112 is a central processing unit that is the nucleus of various controls in the printing apparatus 101. Accordingly, the CPU 112 controls the printing apparatus 101 itself based on various control programs.

The CG-ROM 113 is character generator memory in which image data of a character or symbol to be printed is related to code data and stored in the form of a dot pattern. The EEPROM 114 is non-volatile memory that allows writing and erasing of stored contents. The ROM 115 stores various control programs and data used at the printing apparatus 101. The RAM 116 temporarily stores a computation result by the CPU 112, or the like. The RAM 116 further stores data such as edited print data.

The control unit 111 is coupled to the head driving circuit 117 and the conveying motor driving circuit 118. The head driving circuit 117 is a circuit that supplies the thermal head 102 with a drive signal based on a control signal from the CPU 112 and controls the driving state of the thermal head 102. The conveying motor driving circuit 118 is a circuit that supplies the medium conveying motor 119 with a drive signal based on a control signal from the CPU 112 and controls the rotation of the platen roller 103 through the drive control of the medium conveying motor 119.

The multicolor thermosensitive medium 1 held between the thermal head 102 and the platen roller 103 is pressed onto the thermal head 102 with the platen roller 103 when conveyed by the rotation of the platen roller 103. Here, the side of the overcoating layer 9 coating the black coloring layer 6 (see FIG. 1) is pressed onto the thermal head 102, with respect to the multicolor thermosensitive medium 1.

The thermal head 102 applies thermal energy for the color development of the multicolor thermosensitive medium 1. As mentioned in the above, the overcoating layer 9 covering the black coloring layer 6 in the multicolor thermosensitive medium 1 is pressed onto the thermal head 102, so that the thermal energy of the thermal head 102 is applied onto the multicolor thermosensitive medium 1 from the side of the overcoating layer 9 coating the black coloring layer 6.

Here, the heating temperature and the heating duration of the thermal head 102 is controlled by a unit of print cycle in accordance with the coloring properties of a coloring layer intended to develop a color among the cyan, magenta, yellow and black coloring layers 3, 4, 5, 6 in the multicolor thermosensitive medium 1, by the control unit 111 and the head driving circuit 117.

That is, the control unit 111 and the head driving circuit 117 controls the application duration and the application timing of the driving voltage to the thermal head 102 by a unit of print cycle, so as to control the heating temperature and the heating duration of the thermal head 102 in accordance with the coloring properties of a coloring layer intended to develop a color in the multicolor thermosensitive medium 1 among the cyan, magenta, yellow and black coloring layers 3, 4, 5, 6.

### [2-1. Color Development Control 1]

In FIG. 5, the waveforms indicate application durations of the driving voltage to the thermal head 102 of the printing apparatus 101, in two consecutive units of print cycles. The drive control shown by the waveforms in FIG. 5 is an example of a drive control appropriate for color development in the multicolor thermosensitive medium 1 having the coloring properties as shown in FIG. 2.

As has been discussed in the above, as to the coloring properties shown in FIG. 2, each of the cyan, magenta, yellow and black coloring layers 3, 4, 5, 6 has coloring properties different in a time duration and a temperature level (tolerable duration of heating) necessary for color development. Furthermore, the time duration necessary for color development is the longest at the cyan coloring layer 3 laminated in the layer closest to the base material, and becomes shorter as going upwards in the lamination order; namely, the magenta, yellow and black coloring layers 4, 5, 6, in this order.

Here, in the drive control shown with the waveforms in FIG. 5, the application durations of the driving voltage to the thermal head 102 for color development in the multicolor thermosensitive medium 1 are independently set for the black, yellow, magenta and cyan coloring layers 6, 5, 4, 3 in this order, in two consecutive units of print cycles.

If the application durations of the driving voltage to the thermal head 102 is controlled as in the waveforms shown in FIG. 5 to develop colors in the black, yellow, magenta and cyan coloring layers 6, 5, 4, 3, for instance, in the multicolor thermosensitive medium 1 that develops colors, the drive control causes the black, yellow, magenta and cyan coloring layers 6, 5, 4, 3 to develop colors in a belt-like manner with the thermal head 102 as in the sectional view of the multicolor thermosensitive medium 1 in FIG. 4.

In FIG. 4, where there is illustrated timing when each color is developed, “B” stands for the black color, “Y” stands for the yellow color, “M” stands for the magenta color, “C” stands for the cyan color currently developed. This representation is also used in FIG. 5 through FIG. 7 to be later described. Incidentally, the arrangement shown in FIG. 4 is upside down compared with FIG. 8, with regard to positions of the multicolor thermosensitive medium 1, the thermal bead 102 and the platen roller 103, for convenience of explanation. The same can be said regarding FIG. 6 to be later described.

That is, according to the drive control shown in the waveforms of FIG. 5, if the application durations of the driving voltage to the thermal head 102 are controlled to develop a color in the yellow, magenta and cyan coloring layers 5, 4, 3 by the drive control of the print cycle illustrated on the left in FIG. 5, the yellow, magenta and cyan coloring layers 5, 4, 3 develop a color visually different from each single color developed in each of the yellow, magenta and cyan coloring layers 5, 4, 3 in the multicolor thermosensitive medium 1 developing colors by the thermal head 102, as shown in the left portion of the multicolor thermosensitive medium 1 illustrated in FIG. 4, for instance.

Incidentally, in the multicolor thermosensitive medium 1 illustrated in FIG. 4, as the distance from the thermal head 102 becomes longer in the order of the black, yellow, magenta and cyan coloring layers 6, 5, 4, 3, the thermal energy from the thermal head 102 spreads also in the order of the black, yellow, magenta and cyan coloring layers 6, 5, 4, 3. Accordingly, as in the drive control illustrated by the waveforms in FIG. 5, even if a period of maintaining the heating temperature level for each of the black, yellow, magenta and cyan coloring layers 6, 5, 4, 3 is the same, belt-like areas developed at the black, yellow, magenta and cyan coloring layers 6, 5, 4, 3 are getting wider also in the order of the black, yellow, magenta and cyan coloring layers 6, 5, 4, 3.

If the application durations of the driving voltage to the thermal head 102 are controlled by the drive control of the unit of print cycle illustrated on the right in FIG. 5 to develop a color only in the black coloring layer 6, only the black coloring layer 6 develops the color as illustrated in the right portion of the multicolor thermosensitive medium 1 shown in FIG. 4, in the multicolor thermosensitive medium 1 that develops colors by the thermal head 102.

Incidentally, the belt-like area indicated with a chain double-dashed line in FIG. 4 represents an area to develop a color if the driving voltage is turned from OFF to ON in the two consecutive units of print cycles shown in FIG. 5.

### [2-2. Color Development Control 2]

In FIG. 7, the waveforms indicate application durations of the driving voltage to the thermal head 102 of the printing apparatus 101, in two consecutive units of print cycles. The drive control shown by the waveforms in FIG. 7 is an example of a drive control appropriate for color development in multicolor thermosensitive medium 1 having the coloring properties as shown in FIG. 3.

As has been discussed in the above, as to the coloring properties shown in FIG. 3, each of the cyan, magenta and yellow coloring layers 3, 4, 5 has coloring properties different in a time duration and a temperature level (tolerable duration of heating) necessary for color development. Furthermore, the time duration necessary for color development is the longest at the cyan coloring layer 3 laminated in the layer closest to the base material, and becomes shorter as going upwards in the lamination order; namely, the magenta and yellow coloring layers 4, 5, in this order. Meanwhile, the time duration necessary for color development of the black coloring layer 6 includes all the time durations necessary for color development of the cyan, magenta and yellow coloring layers 3, 4, 5, and the temperature level necessary for color development the black coloring layer 6 is higher than any of the temperature levels necessary for color development for the cyan, magenta and yellow coloring layers 3, 4, 5.

Here, in the drive control shown with the waveforms in FIG. 7, the application durations of the driving voltage to the thermal head 102 for color development in the multicolor thermosensitive medium 1 are independently set for the yellow, magenta and cyan coloring layers 5, 4, 3 in this order, in two consecutive units of print cycles. When developing a black color, the application duration is set only for the black coloring layer 6.

If the application durations of the driving voltage to the thermal head 102 is controlled as in the waveforms shown in FIG. 7 to develop colors in the yellow, magenta, cyan and black coloring layers 5, 4, 3, 6, for instance, in the multicolor thermosensitive medium 1 that develops colors, the drive control causes the yellow, magenta, cyan and black coloring layers 5, 4, 3, 6 to develop colors in a belt-like manner with the thermal head 102 as in the sectional view of the multicolor thermosensitive medium 1 in FIG. 6.

That is, according to the drive control shown in the waveforms of FIG. 7, by the drive control, the yellow, magenta and cyan coloring layers 5, 4, 3 develop a color visually different from each single color developed in each of the yellow, magenta and cyan coloring layers 5, 4, 3 in the multicolor thermosensitive medium 1 developing colors by the thermal head 102, as shown in the left portion of the multicolor thermosensitive medium I illustrated in FIG. 6, for instance. Incidentally, in the multicolor thermosensitive medium 1 illustrated in FIG. 6, as the distance from the thermal head 102 becomes longer in the order of the black, yellow, magenta and cyan coloring layers 6, 5, 4, 3, the thermal energy from the thermal head 102 spreads also in the order of the black, yellow, magenta and cyan coloring layers 6, 5, 4, 3. Accordingly, as in the drive control illustrated by the waveforms in FIG. 7, even if a period of maintaining the heating temperature level for each of the yellow, magenta and cyan coloring layers 5, 4, 3 is the same, belt-like areas developed at the yellow, magenta and cyan coloring layers 5, 4, 3 are getting wider also in the order of the yellow, magenta and cyan coloring layers 5, 4, 3.

If the application durations of the driving voltage to the thermal head 102 are controlled by the drive control of the unit of print cycle illustrated in FIG. 7 to maintain the heating temperature level necessary for developing a color at the black coloring layer 6 for a period equivalent to the sum of periods of maintaining the heating temperature levels for the yellow, magenta and cyan coloring layers 5, 4, 3, respectively, the black coloring layer 6 develops the color in a solid state as illustrated in FIG. 6, in the multicolor thermosensitive medium I that develops colors by the thermal head 102.

### [3. Conclusion]

According to the present embodiment, the thermal energy from the thermal head 102 of the printing apparatus 101 is provided from the side of the overcoating layer 9 covering the black coloring layer 6 in the multicolor thermosensitive medium 1, so that even while the dispersion of the thermal energy is partial in the multicolor thermosensitive medium 1, the thermal energy from the thermal head 102 of the printing apparatus 101 has an effect on the black coloring layer 6 (see FIG. 1 and FIG. 8). Furthermore, a portion where the color is developed in the black coloring layer 6 receiving the thermal energy has higher hiding properties than those in the cyan, magenta and yellow coloring layers 3, 4, 5 which lie below the black coloring layer 6 in the multicolor thermosensitive medium 1, and in addition, the black coloring layer 6 develops a color in a temperature higher than those for the cyan, magenta and yellow coloring layers 3, 4, 5 (see FIG. 2 and FIG. 3). As a result, for instance, through executing the drive control to the thermal head 102 of the printing apparatus 101 to apply driving voltage only for developing a color in the black coloring layer 6, it becomes possible that the black coloring layer 6 in the multicolor thermosensitive medium 1 develops the color in the high temperature at the thermal head 102 of the printing apparatus 101, so that there can be inhibited color mixture due to color development of the cyan, magenta and yellow coloring layers 3, 4, 5, enabling clear and sharp printing with an outline or a character distinctly depicted.

When executing the drive control to apply the driving voltage for developing a color only in the black coloring layer 6 comparatively long time to the thermal head 102 of the printing apparatus 101, for instance, as in the right portion of the multicolor thermosensitive medium 1 illustrated in FIG. 6, the black coloring layer 6 develops the color in the solid state. Here, even if any of the cyan, magenta and yellow coloring layers 3, 4, 5 develops a color in portions each indicated with a chain double-dashed line in the right portion of the multicolor thermosensitive medium 1 illustrated in FIG. 6, the black coloring layer 6 above the cyan, magenta and yellow coloring layers 3,4,5 has already developed the color, and the black is the darkest of all (has the highest hiding properties), so that none of the cyan, magenta and yellow colors in the multicolor thermosensitive medium 1 can be seen through the side of the overcoating layer 9. That is, in the drive control illustrated with the waveforms in FIG. 7, the application duration of the driving voltage to the thermal head 102 to develop a color in the black coloring layer 6 is set comparatively long, so that, as shown in the right portion of the multicolor thermosensitive medium 1 illustrated in FIG. 6, the black color is developed in the solid state. Accordingly, in the multicolor thermosensitive medium 1 that has developed a color by the drive control at the thermal head 102, the cyan, magenta and yellow colors cannot be seen through even if developed.

Furthermore, according to the present embodiment, if the thermal energy from the thermal head 102 of the printing apparatus 101 is applied on the multicolor thermosensitive medium 1 from the side of the overcoating layer 9 covering the black coloring layer 6 at a high temperature for a short period if time (see FIG. 1, FIG. 2 and the right portion of FIG. 5), the black coloring layer 6 can be independently developed in the multicolor thermosensitive medium 1. Therefore, this control also makes it possible to print clearly and sharply with an outline or a character distinctly depicted.

Furthermore, according to the present embodiment, by the thermal energy from the thermal head 102 of the printing apparatus 101, the black coloring layer 6 in the multicolor thermosensitive medium 1 develops a color at a high temperature in a short period of time, and the cyan, magenta and yellow coloring layers 3, 4, 5 in the multicolor thermosensitive medium 1 develop colors at lower temperatures in longer periods of time, compared with the case of the black coloring layer 6, based on the coloring properties illustrated in FIG. 2. As a result, in a case where there are no background colors such as cyan, magenta and yellow and only an outline or a character in black is developed in the multicolor thermosensitive medium 1, the printing speed in the printing apparatus 101 can be made faster.

### [4. Other]

It is to be noted that the disclosure is not restricted to aspects directed to the present embodiment and that various changes and modification may be made without departing from the gist of the disclosure. There may be modified as below.

For instance, in the embodiment, the lamination group 7 laminated on the base material 2 of the multicolor thermosensitive medium 1 is composed of the cyan, magenta and yellow coloring layers 3, 4, 5; however, any coloring layer of a basic color that satisfies the coloring properties can be employed instead of the combination of the cyan, magenta and yellow coloring layers, and the number of coloring layers may be one layer, two layers, four layers or more.

Further, if the intermediate layers 8 in the multicolor thermosensitive medium 1 are made of a flexible heat-insulating material, the multicolor thermosensitive medium 1 can be wound into a small roll, so that the multicolor thermosensitive medium 1 can be stored in larger amount.

Still further, if the intermediate layer 8 below the black coloring layer 6 in the multicolor thermosensitive medium 1 is a heat-insulating layer with a prescribed thickness and high thermal conductivity, the color developed in the black coloring layer 6 can be made more distinct and the black outline or character can be seen standing out on the multicolor thermosensitive medium 1. For instance, the insulating layer here is made thicker than a usual intermediate layer, as well as having high thermal conductivity so as not to change the amount of heat transmitted.

While presently exemplary embodiments have been shown and described, it is to be understood that this disclosure is for the purpose of illustration and various changes and modifications may be made without departing from the scope of the disclosure as set forth in the appended claims.

What is claimed is:

1. A multicolor thermosensitive medium and a printing apparatus, wherein the multicolor thermosensitive medium comprises:
a base material; and
a plurality of coloring layers comprising:
a lamination group laminated on the base material and comprising one or more lower coloring layers each of which develops a basic color; and
an upper coloring layer that develops a color different from basic colors developed at the lower coloring layers, the upper coloring layer laminated on the lamination group and having higher hiding properties at a portion where the color is developed than the lower coloring layers,
wherein each coloring layer has coloring properties different from each other with regard to a heating temperature level necessary for color development, and
wherein the upper coloring layer develops the color at a higher temperature than any of the lower coloring layers in the lamination group, and
wherein the printing apparatus comprises:
a thermal head that applies thermal energy to the multicolor thermosensitive medium from a direction of the upper coloring layer; and
a control means that drives the thermal head,
wherein the control means controls a heating temperature at the thermal head by a unit of print cycle, in accordance with coloring properties of a coloring layer to be developed among the upper coloring layer and the lower coloring layers.

2. The multicolor thermosensitive medium and the printing apparatus according to claim 1, wherein the color to be developed at the upper coloring layer is black.

3. The multicolor thermosensitive medium and the printing apparatus according to claim 1, wherein the control means controls an application duration and application timing of driving voltage to the thermal head by the unit of print cycle to control a heating temperature and a heating duration in accordance with heating properties of a coloring layer to be heated.

4. The multicolor thermosensitive medium and the printing apparatus according to claim 3, wherein the lamination group in the multicolor thermosensitive medium comprises two or more lower coloring layers, each of which has coloring properties different from each other with regard to a tolerable range of the heating duration necessary for color development.

5. The multicolor thermosensitive medium and the printing apparatus directed to claim 3, wherein each coloring layer in the multicolor thermosensitive medium has coloring properties different from each other with regard to a tolerable range of the heating duration necessary for color development.

6. The multicolor thermosensitive medium and the printing apparatus according to claim 1, wherein the lamination group in the multicolor thermosensitive medium comprises two or more lower coloring layers, and color development of the two or more lower coloring layers causes to develop a color visually different from respective colors that the two or more lower coloring layers individually develop.

7. The multicolor thermosensitive medium and the printing apparatus according to claim 1, wherein an intermediate layer is laminated between coloring layers in the multicolor thermosensitive medium.

8. The multicolor thermosensitive medium and the printing apparatus according to claim 1, wherein an overcoating layer is laminated on the upper coloring layer in the multicolor thermosensitive medium.

9. The multicolor thermosensitive medium and the printing apparatus according to claim 1, wherein the lamination group comprises three lower coloring layers, at which colors to be developed are cyan, magenta and yellow, respectively.

10. The multicolor thermosensitive medium and the printing apparatus according to claim 3, wherein, among the lower coloring layers in the multicolor thermosensitive medium, a heating duration necessary for color development is longest in a coloring layer closest to the base material, and gets shorter in an order of lamination toward the upper coloring layer.

11. A multicolor thermosensitive medium and a printing apparatus, wherein the multicolor thermosensitive medium comprises:
a base material; and
a plurality of coloring layers comprising:
a lamination group laminated on the base material and comprising one or more lower coloring layers each of which develops a basic color; and
an upper coloring layer that develops a color different from basic colors developed at the lower coloring layers, the upper coloring layer laminated on the lamination group and having higher hiding properties at a portion where the color is developed than the lower coloring layers,
wherein each coloring layer has coloring properties different from each other with regard to a heating temperature level necessary for color development, and
wherein the upper coloring layer develops the color at a higher temperature than any of the lower coloring layers in the lamination group,
wherein the printing apparatus comprises:
a thermal head that applies thermal energy to the multicolor thermosensitive medium from a direction of the upper coloring layer; and
a control means that drives the thermal head,
wherein the control means controls a heating temperature at the thermal head by a unit of print cycle, in accordance with coloring properties of a coloring layer to be developed among the upper coloring layer and the lower coloring layers,
wherein the color to be developed at the upper coloring layer is black, and
wherein the lamination group comprises three lower coloring layers, at which colors to be developed are cyan, magenta and yellow, respectively.

12. The multicolor thermosensitive medium and the printing apparatus according to claim 11, wherein:
among the upper coloring layer for black and the lower coloring layers for cyan, magenta and yellow included in the multicolor thermosensitive medium, a heating duration necessary for color development is longest in a lower coloring layer for cyan which is laminated closest to the base material, and gets shorter in an order of lamination, that is: a lower coloring layer for magenta, a lower coloring layer for yellow and the upper coloring layer for black which is laminated most distant from the base material, and
among the upper coloring layer for black and the lower coloring layers for cyan, magenta and yellow included in the multicolor thermosensitive medium, a heating temperature level necessary for color development is lowest in the lower coloring layer for cyan which is laminated closest to the base material, and gets higher in the order of lamination, the lower coloring layer for magenta, the lower coloring layer for yellow and the upper coloring layer for black which is laminated most distant from the base material.

13. The multicolor thermosensitive medium and the printing apparatus according to claim 11, wherein:
among the lower coloring layers for cyan, magenta and yellow included in the multicolor thermosensitive medium, a heating duration necessary for color development is longest in a lower coloring layer for cyan which is laminated closest to the base material, and gets shorter in an order of lamination, a lower coloring layer for magenta and a lower coloring layer for yellow,
among the lower coloring layers for cyan, magenta and yellow included in the multicolor thermosensitive medium, a heating temperature level necessary for color development is lowest in the lower coloring layer for cyan which is laminated closest to the base material, and gets higher in the order of lamination, that is: the, lower coloring layer for magenta and the lower coloring layer for yellow, and
a heating duration necessary for color development of the upper coloring layer for black included in the multicolor thermosensitive medium includes all heating durations necessary for color development of the lower coloring layers for cyan, magenta and yellow included in the multicolor thermosensitive medium, while the heating temperature level necessary for color development at the upper coloring layer for black is higher than any of the lower coloring layers for cyan, magenta and yellow included in the multicolor thermosensitive medium.
